(19) United States
(12) Patent Application Publication
(10) Pub. No.: US 2004/0021006 A1
(43) Pub. Date: Feb. 5, 2004

(54) Spray apparatus

(76) Inventor: Nicholas Ian Mounteney, Cambridgeshire (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/217,658

(22) Filed: Aug. 12, 2002

(30) Foreign Application Priority Data
Jul. 31, 2002 (GB) GB 0217725.1

(51) Int. Cl. B05B 1/08

(52) U.S. Cl. 239/398; 239/102.2; 239/10; 239/4

(57) ABSTRACT

Apparatus for spraying a range of mixtures of two or more fluids, comprising: a body defining a passageway for conveying gas flowing through the body from an inlet to an outlet, the outlet comprising at least two apertures, each aperture having a fluid supply positioned to entrain fluid in gas flowing from its respective aperture; and a regulator for regulating gas flow through each of the apertures, whereby relative quantities of fluid from the respective fluid supplies entrained in gas flowing from the outlet is dependent upon regulation of gas flowing through the apertures.

### BACKGOUND OF THE INVENTION

The present invention relates to a method and apparatus for spraying a range of mixtures of two or more fluids, and particularly but not exclusively, to a method and apparatus for spraying a range of mixtures of two or more different liquid colourants (e.g. inks in three primary colours) to produce various coloured shades.

Airbrushes are one known form of spray apparatus and have been around for many years and operate in various ways. A common technique used by airbrush manufactures to produce a fine spray is to atomise fluid by drawing it up from a reservoir through a tube and passing high velocity air over the end of the tube, known as the Venturi effect. The fine liquid particles are dispensed on to a target substrate (e.g. paper) in a thin layer to form a coloured coating.

Airbrushes commonly have a reservoir containing liquid colourant hanging below or protruding above a pen-like structure. This extra mass requires that the operator has a high degree of control in order to control the destination of the colourant. However, this is not the only disadvantage with such arrangements.

Cheap airbrushes provide a simple on/off air valve, which makes it difficult to control the volume dispensed and can lead to overspraying. More expensive models provide more control over flow but a high degree of skill is still required to operate them, because of the complexity of the valves.

Changing spray colour is not a trivial exercise, since a conventional airbrush needs to be dismantled and cleaned with water or solvent prior to introducing a different liquid colourant. Also, the liquid colourant needs to be pre-selected which may necessitate mixing different colours externally by hand to produce the desired shade. Alternatively a desired shade may be produced by lightly spraying one colour over an existing colour, in much the same way a colour printer produces a shade. However, this requires great skill to produce the desired shade.

Spray-gun devices which allow mixing of the liquids to be sprayed are known in the art, examples of which are disclosed in prior art documents WO 84/01525 (Rijlaarsdam), WO 97/20585 (Bristol-Myers Squibb), U.S. Pat. No. 5,713,519 (Minnesota Mining) and JP 09-299833 (Kansai Paint Co Ltd), all of which use high-pressure gas streams to deliver the liquids to their intended target.

The combination of issues relating to user skill, mess, cost and use of high-pressure air frequently discourage the use of airbrushes by children and indeed many adults. Thus, it is an object of the present invention to address some of the aforementioned disadvantages associated with conventional airbrushes.

### SUMMARY OF THE INVENTION

In accordance with one aspect of the present invention, there is provided apparatus for spraying a range of mixtures of two or more fluids, comprising: a body defining a passageway for conveying gas flowing through the body from an inlet to an outlet, the outlet comprising at least two apertures, each aperture having a fluid supply positioned to entrain fluid in gas flowing from its respective aperture; and a regulator for regulating gas flow through each of the apertures, whereby relative quantities of fluid from the respective fluid supplies entrained in gas flowing from the outlet is dependent upon regulation of gas flowing through the apertures.

The present applicant has appreciated the advantage of regulating the gas flow through the outlet apertures of the passageway to control the ratio of fluids from the respective supplies in the spray from the outlet (hereinafter referred to as the “spray ratio”). For example, the apparatus may be used to spray only a first fluid from a first supply, only a second fluid from a second supply, or any mixture of fluids from any other supplies provided, simply by controlling the regulator. Thus, there is substantially no down-time associated with changing from one spray ratio to another. During spraying, the gas flowing from the outlet apertures may mix in flight, thereby allowing particles of the fluids being sprayed to become interspersed, or even fused together. Different colours and shades may also be produced by impingement on the target substrate, as is done in inkjet printing. The gas flowing from the outlet apertures may be directed to a common focus point to encourage mixing of entrained fluids or at least the gas flows in which fluids are entrained.

The present invention is particularly suited to spraying a range of mixtures of at least two coloured liquids or colourants to produce varying composite shades of colour. For example, a full range of colours or hues from yellow-to-green-to-blue may be produced by controlling relative quantities of yellow and blue ink entrained in the gas flowing from the outlet. Of course, the outlet may further comprise a third aperture configured to entrain in gas flowing therefrom fluid from another supply, and the regulator may regulate gas flowing through the third aperture in addition to the other apertures. In this way, for example, a full (rainbow) spectrum of colours may be produced from red, yellow and blue-coloured inks, simply by varying the spray ratio.

At least one fluid supply may atomise the fluid prior to entrainment in gas flowing from its respective aperture. For example, a piezoelectric ink-jet device could be employed to atomise fluid directly into the flowing gas. In another form of the present invention, the flow of gas itself may be used to bring about fluid entrainment, even a gas flow generated by a gas source which in the present context a man skilled in the art would regard as being of low pressure. For instance, the gas pressure required to operate the present invention may be less than 1 bar (1×10⁵ Nm⁻²), for example 3×10⁴ Nm⁻² (4 psi). With such a low pressure source, a sufficiently high velocity gas flow for fluid entrainment may be attained by using the apertures to constrict the passageway at the outlet. Such low pressures are ideally suited to toy applications (e.g. multi-shade spray pen), both because the gas flows involved are unlikely to cause serious injury and because they are readily generated e.g. by hand pump, bellows or even battery-operated pump. However, the present invention may prove useful in fields outside toys, such as in low resolution printing applications or even in two component spraying applications where the two components react to produce a third component when mixed together (e.g. glues, sealants and the like).

In one embodiment, at least one fluid supply comprises a member configured to receive fluid from a reservoir through capillarity. Such use of capillary action alleviates and possibly obviates the need for high pressure gas flows since much less energy is required to atomise the fluids than with conventional Venturi effect devices (the latter devices require high pressure to draw fluid up relatively long tubes by Venturi effect prior to atomisation). Instead, fluid is delivered by capillarity to a point where it may be atomised from the member in high velocity gas flows without the need for large pressure differentials. The capillary action will also resist leakage of fluid from the fluid supply when the fluid is not required.

The member may comprise a capillary tube in fluid communication with its respective reservoir. The reservoir may comprise a chamber housing absorbent material adjacent one end of the capillary tube. The chamber stores fluid but allows it to be drawn into the capillary tube by capillarity, even when the direction of flow is against gravity. Thus, the spray ratio may be maintained, even if the relative orientation of the apparatus suddenly changes during use.

The member may comprise a wicking material in fluid communication with the reservoir. The wicking material may comprise aligned fibres or a porous material (e.g. sintered structure). The member may have a tip which has a peripheral surface inclined at an acute angle to the direction in which gas flows through the respective part of the passageway. In this way, any gas flow is prevented from forcing fluid back through the wicking material towards the reservoir. The member may further comprise an apertured cover plate which shields the wicking material from any gas flow (the cover plate may be an alternative embodiment to the capillary tube). Fluid from the reservoir soaks the wicking material and is drawn through one or more apertures in the cover plate through capillarity. The one or more apertures may be shaped or positioned to achieve a desired spray profile. For example, the spray profile may be fan-shaped (for block spraying) or beam-shaped (for line spraying). The cover plate with a first aperture shape or position may be releasable and interchanged with another cover plate with a second aperture shape or position in order to alter the spray profile. The cover plate and wicking material may be configured as a single unit to be released and interchanged en bloc.

In one embodiment, the apparatus may comprise a plurality of interchangeable supply assemblies, each comprising members configured to deliver fluids from reservoirs to their respective fluid supplies, each member comprising a wicking material with an individual cover plate. The apertures in the cover plate of one supply assembly may have a different configuration to those of another supply assembly. Such supply assemblies may have advantages over en bloc cover plates, for example a greater range of shading may be achieved through changing from mixing primary colours to mixing subtle shades. The supply assemblies may be provided in plate-form.

The regulator may comprise at least two valves located in the passageway, each valve being configured to regulate gas flowing through a respective outlet aperture. Each valve may comprise an open vent configured to exhaust gas before reaching its respective aperture until the vent is sealed. The open vent may be sealed manually either directly with a user's fingers (just as holes on a musical instrument such as a recorder are stopped with fingers) or indirectly with finger operated keys (just as in a musical instrument such as a flute). Alternatively, the open vent may be sealed electro-mechanically, for example by piezoelectric driven flaps or needles (with movement being parallel or to gas flow) each possibly linked via a controller to determine a degree of actuation.

In another-embodiment, the regulator may comprise a rotary valve positioned upstream of the outlet apertures. The rotary valve may comprise an arcuate member with at least one channel therethrough, the at least one channel being registrable with one or other part of the passageway by rotation of the arcuate member relative thereto. The arcuate member may have at least two channels therethrough, with one channel having a different geometric profile to another, e.g. one channel may be wider than the other. In this way, use of one channel may produce a different spray ratio than use of the other channel.

The arcuate member may be releasable and interchangeable with a replacement arcuate member, the said arcuate member having a different channel configuration to that of the replacement arcuate member. By using different channel configurations, different spray ratios may be attainable, particularly when the passageway has three (or more) parts each having its own respective fluid supply.

The position of the or each channel in the arcuate member relative to the outlet apertures may be controlled through gearing. The spray ratio may change even in response to very slight movements of the arcuate member. Thus, gearing may give a degree of fine control by scaling down rotary movements.

The apparatus may further comprise at least two reservoirs, each for supplying fluid to a respective fluid supply. The at least two reservoirs may be integrally formed in the body defining the passageway. The integrally formed reservoirs may be refillable, for example using a syringe. Alternatively, the at least two reservoirs may be in cartridge form. Cartridge form would offer the advantage of being replaceable when spent. The cartridge form may include any wicking material employed to deliver stored fluid to the gas stream. In this way, cartridges storing different colourants may be interchanged without cross contamination problems.

In one form of the present invention, the regulator may comprise a final assembly which forms a single component capable of addressing and regulating individually or simultaneously the gas flow of multiple outlets. In another form of the present invention, the gas flow from the outlet apertures may be regulated by preferentially addressing each aperture. In another form of the present invention, the area of the aperture of the fluid delivery aperture is less than one hundred percent of the area of the gas delivery aperture. In another form of the present invention, the centreline position for the aperture of the fluid delivery aperture with respect to the centreline position of the gas delivery orifice in planes X, Y is positioned within a tolerance of fifty percent of the gas outlet aperture area in either direction. In another form of the present invention, the distance in the Z plane between the fluid delivery aperture and the gas delivery aperture falls within a tolerance of five times that of the outlet area of the gas delivery aperture.

In accordance with a second aspect of the present invention, there is provided a method of spraying a range of mixtures of at least two fluids, comprising: providing spray apparatus comprising a body defining a passageway with an inlet and an outlet, the outlet comprising at least two apertures; supplying at least two fluids, each for entrainment in gas flowing from a respective aperture; regulating gas flow through each aperture to entrain an amount of each fluid in dependence upon gas flowing from its respective aperture; and mixing gas flowing from each aperture to mix entrained fluids.

In the method, at least two fluids may each be supplied from a respective reservoir through capillary action. Other features of the spray apparatus may be in accordance with embodiments of the first aspect of the present invention.

According to another aspect of the present invention, there is provided apparatus for spraying a fluid, comprising: a body defining a passageway for conveying gas flowing through the body from an inlet to an outlet; and a fluid supply configured to deliver fluid from a reservoir for entrainment in gas flowing through the body, wherein the fluid supply comprises a member configured to receive fluid from the reservoir through capillarity. The member may comprise a capillary tube, one end of which is in contact with an absorbent material which in use is soaked with fluid. The absorbent material may be configured to supply fluid to the capillary tube even when the absorbent material is not longer in fluid communication with fluid in reservoir. The capillary tube may be configured as an aperture in a cover plate positioned between the absorbent material and the gas flowing through the body. The absorbent material may be configured as a wick, and may be selected from the group consisting of aligned fibres and sintered materials.

### BRIEF DESCIPTION OF THE DRAWINGS

Embodiments of the invention will now be described by way of example with reference to the accompanying drawings in which:

FIG. 1 is a schematic cross-sectional side view of a spray pen embodying one aspect of the present invention;

FIG. 1A shows schematically bleed valve detail of the spray pen in FIG. 1;

FIG. 2 is a schematic cut-away plan view of the spray pen of FIG. 1;

FIG. 2A shows schematically outlet aperture and fluid supply detail of the spray pen of FIG. 1;

FIG. 2B shows schematically the geometric position of an outlet aperture and respective fluid supply of the spray pen of FIG. 1;

FIG. 2C shows schematically the geometric orientation of an outlet aperture and fluid supply of the spray pen of FIG. 1;

FIG. 3 is a schematic cross-sectional view of the spray pen of FIG. 1 along line III-III;

FIG. 4 shows schematically an alternative fluid supply arrangement for use in a spray pen;

FIG. 5 shows detail of the alternative fluid supply of FIG. 4;

FIG. 6 shows details of a replacement for the alternative fluid supply of FIG. 5;

FIGS. 7A to 7C show schematically different configurations of a rotary valve for the regulator used in the spray pen shown in FIG. 1;

FIG. 8 shows schematically an alternative embodiment of the spray pen.

FIG. 9 shows schematically another alternative fluid supply arrangement for use in a spray pen; and

FIGS. 10A to 10C show schematically different configurations of a linear valve for the regulator used in the spray pen shown in FIG. 1.

### DESCRIPTION OF THE SPECIFIC EMBODIMENTS

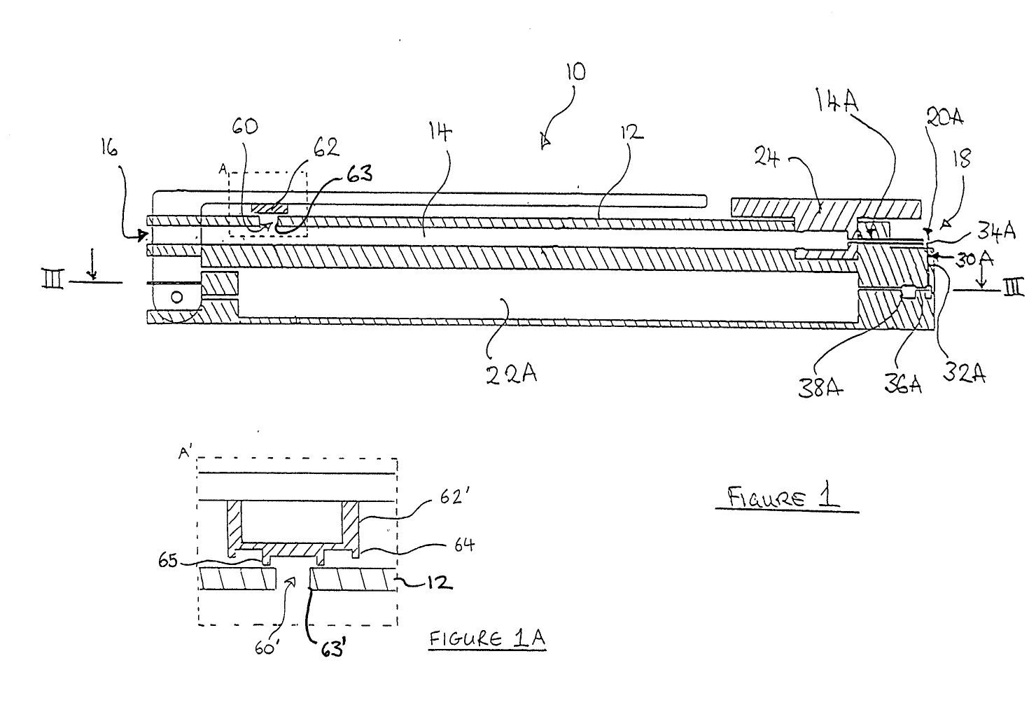

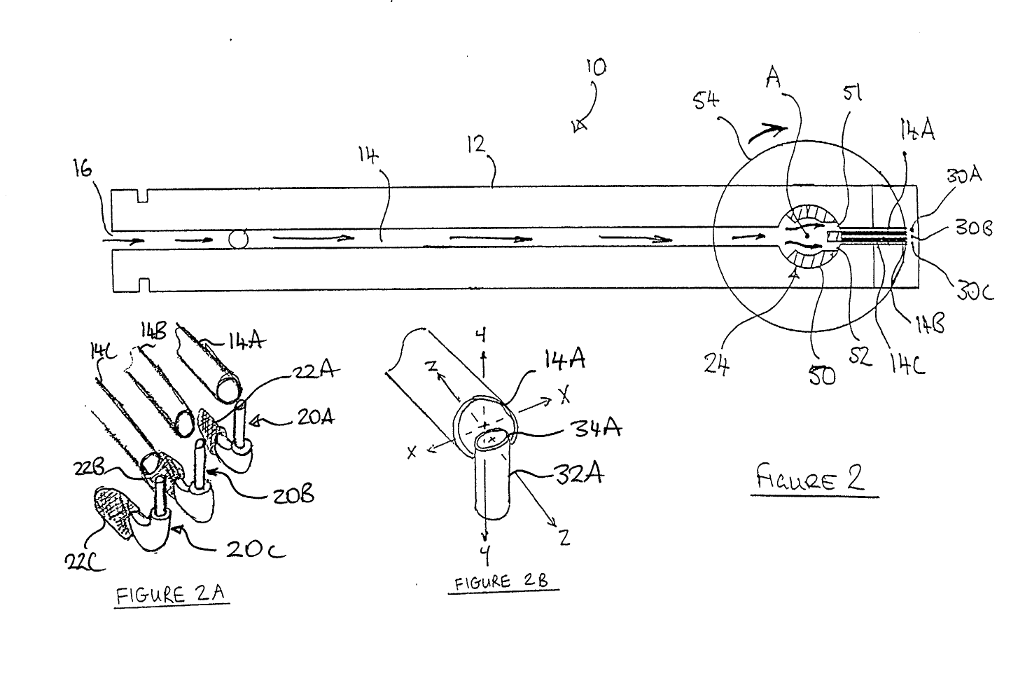

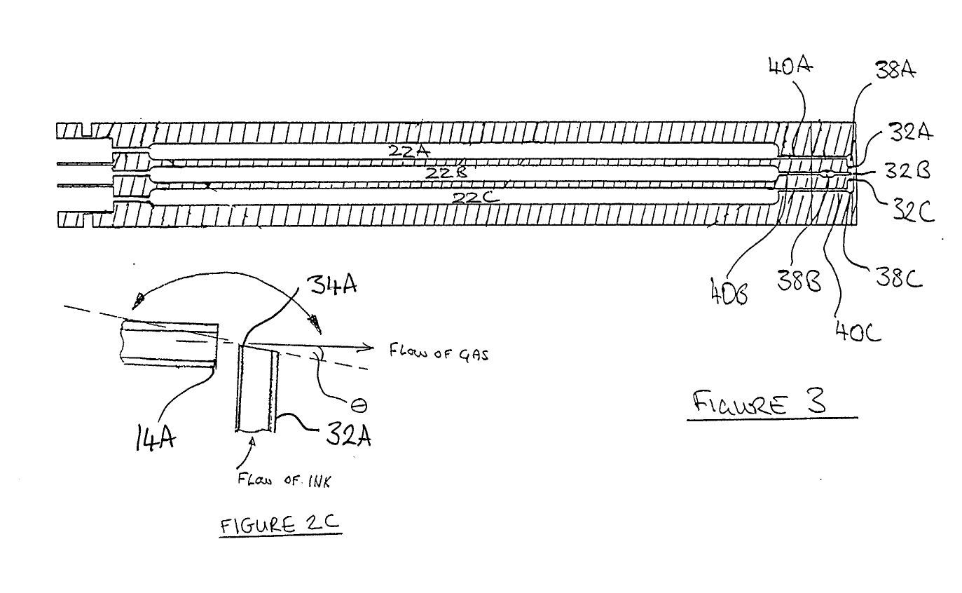

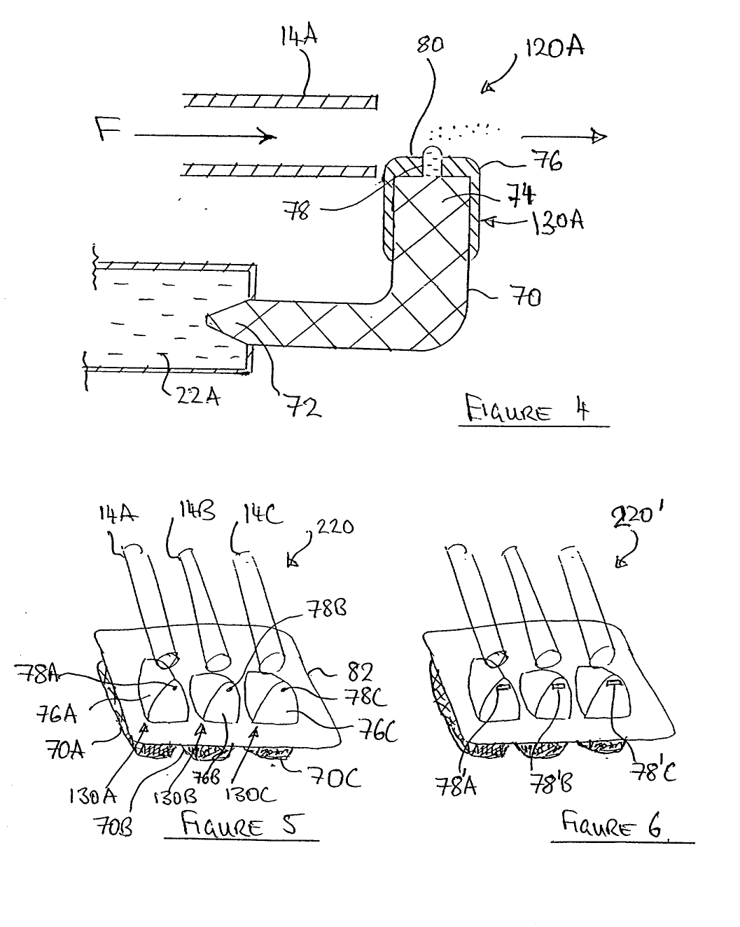

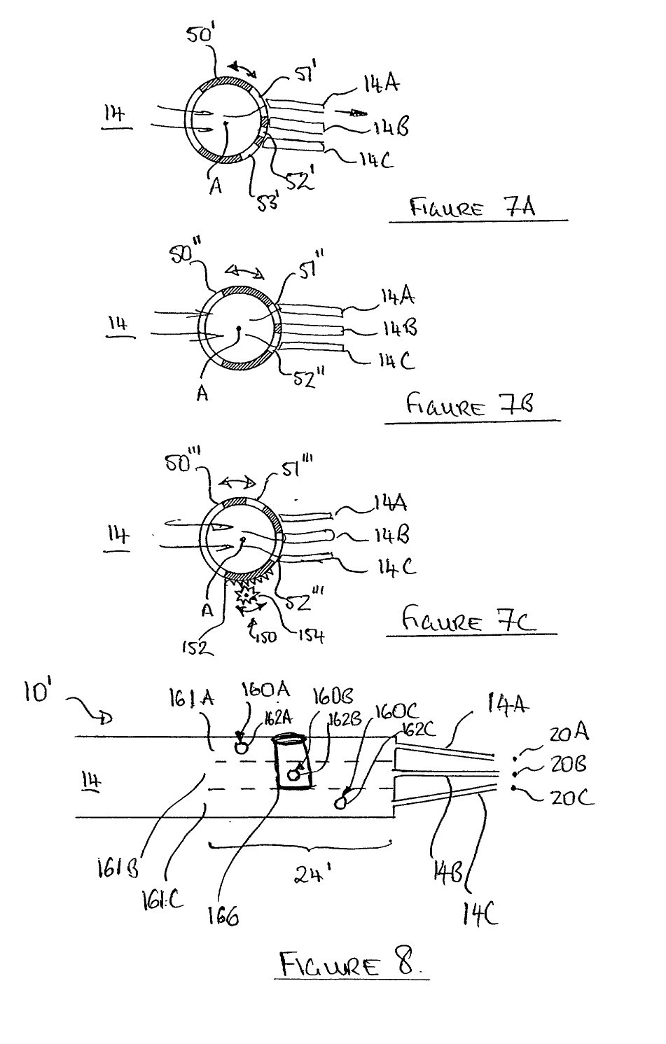

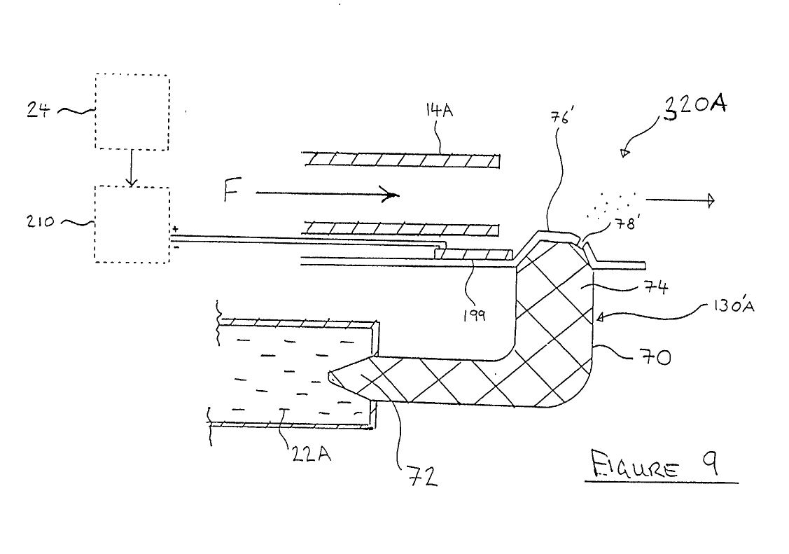

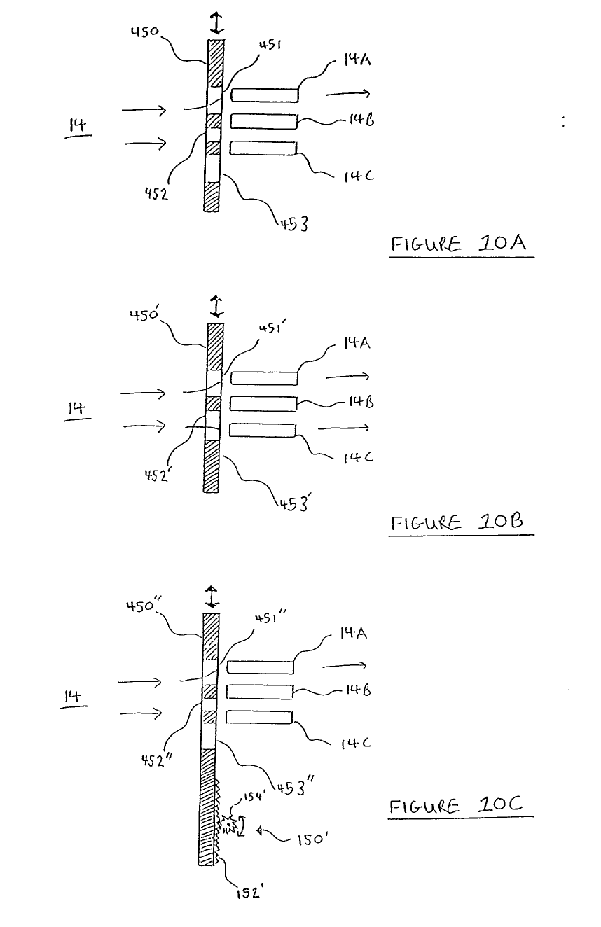

FIGS. 1 and 2 show a hand-held spray pen (10) embodying the present invention. The spray pen (10) comprises a body (12) defining a passageway (14), with an inlet (16) for receiving air (low pressure/high velocity) from a pump (not shown) and an outlet (18). The outlet (18) of passageway (14) comprises three nozzles or apertures (14A,B,C) each of which defines a bore configured to direct air flowing therethrough towards a respective fluid supply (20A,B,C). Each fluid supply (20A,B,C) receives ink from a respective reservoir (22A,B,C), with the ink in each reservoir being one of three different colours such as red, yellow and blue. A regulator (24) is located in passageway (14) and regulates air flowing through each of the three apertures (14A,B,C). When air flows through one of the apertures (14A,B,C), ink from its respective fluid supply (20A,B,C) is atomised and becomes entrained in the gas flow from outlet (18). Thus, when air flows simultaneously through two or more apertures (14A,B,C), inks from their respective fluid supplies (20A,B,C) are atomised and become entrained in the gas flow from outlet (18). The fluid supplies (20A,B,C) are positioned so that the fluids entrained in the gas flow are directed to a common focal point in front of the spray pen, thereby causing the entrained inks to impinge on a substrate to produce a colour shade which depends upon the relative amounts of each coloured ink in the gas flow from the outlet (18) (hereinafter the relative amounts will be referred to as the “spray ratio”). Adjusting the regulator will change the spray ratio.

Each fluid supply (20A,B,C) comprises a member (30A,B,C) which is configured to draw ink from the reservoir by capillary action. In the arrangement shown in FIGS. 1 and 2, each member (30A,B,C) comprises a capillary tube (32A,B,C). For simplicity, only one capillary tube (32A) is shown in certain drawings and will be referred to in the following explanation, although the other capillary tubes 32B and 32C are equivalent. The capillary tube (32A) has a leading end (34A) positioned in the path of air flowing from the outlet aperture (14A). The trailing end (36A) of the capillary tube (32A) communicates with a respective chamber (38A) housing an absorbent material (not shown). The chamber (38A) is fed with ink from its respective reservoir (22A) through feed conduit (40A). When in contact with the conduit (40A), ink from the reservoir (22A) flows along its respective feed conduit (40A) to its respective chamber (38A) wetting the absorbent material in each. The absorbent material holds ink in the chamber (38A) preventing it from flowing back into the reservoir (22A) even when the spray pen (10) is filled up causing ink in the reservoir (22A) to break contact with the conduit (40A). Despite the presence of the absorbent material, ink in the chamber (38A) rises up under capillary action through the capillary tube (32A) until it reaches the leading end (34A). Surface tension prevents the inks from overflowing from the leading end (34A). Nevertheless, low pressure, high velocity gas flowing through the aperture (14A) will atomise the inks, leading to entrainment in the gas flow from outlet (18).

The regulator (24) is a rotary valve and as shown in FIG. 2 includes an arcuate member (50) with a pair of channels (51,52) extending therethrough. By rotating the arcuate member (50) around central axis ‘A’ with knob (54), at least one of the channels (51,52) is brought to register with one of the apertures (14A,B,C) of the passageway (14). It is only when one of the channels (51,52) is registered with one of the apertures (14A,B,C) that air can flow through that aperture. Furthermore, the degree of registration controls the rate at which air flows through that part. In the arrangement shown in FIG. 2, air flows equally through the two channels (51,52) through two of the apertures (14A,C) but not through the third (14B). By rotating the knob (54) in a clockwise direction, the arcuate member (50) will start to restrict air flowing through one (14A) of the two formerly active apertures whilst the other part (14C) remains fully open thereby increasing the possible contribution of the latter to the spray ratio. During this clockwise movement, the third part (14B) remains completely blocked. In this way, one or more parts (14A,B,C) of the passageway (14) may be selected at any one time, and the relative contribution of each selected part to the spray ratio may be varied.

The diameter of the leading ends (34A,B,C) of each capillary tube (32A,B,C) may be up to 120% of the bore diameter of the outlet apertures (14A,B,C). Furthermore, each leading end (34A,B,C) is positioned in front of its respective outlet aperture, in the path of the gas flow, and at a distance of no more than five times the bore diameter of the outlet aperture (14A,B,C) in front of that outlet aperture. The leading end (34A,B,C) of each capillary tube (32A,B,C) is inclined at an angle θ away from the gas flow direction to prevent “blow back”, as shown in FIG. 2C.

In use, air is continuously supplied to the spray pen (10) through inlet (16). A bleed valve (60) is provided in assageway (14) and is configured to vent supplied air when the spray pen (10) is temporarily idle. When spraying is to commence, the valve seal (62) is closed over bleed orifice (63), forcing air to flow along the passageway (14) to the regulator (24). The regulator (24) will have been adjusted so that at least one of the channels (51,52) in the arcuate member (50) is positioned to direct air through one or more apertures (14A,B,C) required to atomise and entrain the inks needed to produce the spray colour of interest. In one arrangement, shown in FIG. 1A, the bleed valve (60′) comprises a multi-staged valve seal (62′). The valve seal (62′) is resilient and has an inner sealing ring (65) which can flex relative to an outer sealing ring (64). The two sealing rings are disposed at different heights so that the bleed orifice (63′) may be partially closed when only the inner ring (65) engages the body (12)—flexure allows gas to escape past the inner ring (65)—or completely closed when both rings engage the body (12).

FIG. 4 shows an alternative fluid supply arrangement (120A,B,C) which may be used in place of one fluid supply (20A,B,C). The alternative fluid supply (120A,B,C) still utilises capillary action, but is configured differently to that of fluid supply (20A,B,C). [For simplicity, only one such supply (120A) is shown, but the other supplies (120B,C) would be equivalent.] The fluid supply (120A) comprises a member (130A) which comprises a wick (70). The wick (70) may comprise aligned fibres or may even comprise a sintered component. The latter may be readily formed into complex shapes, for example with a 90° curve or bend which may make it easier to align elongate reservoirs with the passageway (14) and still deliver ink for entrainment in gas flowing from apertures (14A,B,C); the wick may even be flexible. One end (72) of the wick is in contact with the ink in its respective reservoir (22). The other end (74) of the wick (70) is shrouded with an apertured cover plate (76) which has an aperture (78). The cover plate (76) is positioned with the aperture (78) in the path of air flowing (in direction of arrow F) from aperture (14A). The wick (70) draws ink via capillary action from the reservoir (22A). When ink reaches the cover (76), it is drawn through the aperture (78) by capillary action. Surface tension prevents the ink from overflowing from the upper surface (80) of the cover (76). Nevertheless, ink exposed at the upper surface (80) of the cover (76) is atomised and entrained when exposed to low pressure/high velocity gas flowing over it.

FIG. 5 shows one form (220) of the alternative fluid supply arrangement (120A,B,C), where the members (130A,B,C) for each are set in a single plate (82) for ease of interchange with alternative arrangements (220′) (see below). Thus, the plate (82) includes integrally formed covers (76A,B,C), each with an aperture (78A,B,C). The wicking materials (70A,B,C) are aligned with their respective covers (76A,B,C) and are possibly bonded to the underside of the plate (82). In use, the wicking materials (70A,B,C) will be in contact with ink in respective reservoirs (22A,B,C) and will supply ink to their respective apertures (78A,B,C). The geometry of the apertures (78A,B,C) on the upper surface (80) of the covers (76A,B,C) will have an effect on the spray pattern produced by the spray pen (10). Thus, for example, an aperture with a circular geometry may produce a narrow beam of entrained ink, whereas an aperture with a wider, rectangular geometry may produce a more diverse beam of entrained ink. If the user wishes to switch from “point” spray to “fan” spray (e.g. for block shading large areas instead of spraying in fine lines), the fluid supply arrangement (220) (with circular apertures (78A,B,C) may be replaced by the supply arrangement (220′) shown in FIG. 6 which has rectangular apertures (78′A,B,C).

FIGS. 7A to 7C show various replacement arcuate members (50′,50″,50′″) which may be used in place of arcuate member (50) in regulator (24) to provide different spray ratio permutations. Thus, the arcuate member 50′ includes three channels (51′,52′ and 53′), each of different width or gauge. On the other hand, arcuate member 50″ includes two channels (51″ and 52″) of different gauges. With regard to arcuate member 50′″, a simple gearing arrangement (150) is illustrated schematically in FIG. 7C. By providing the arcuate member 50′″ with gear teeth (152) in meshing engagement with drive cog (154) [which has a smaller diameter than that of arcuate member 50′″], the position of the channels (51′″, 52′″) around axis A (FIG. 2) may be accurately controlled.

FIG. 8 shows schematically an alternative embodiment of the spray pen (10′) in which the regulator (24′) comprises first, second and third valves (160A,B,C) located respectively in channels (161A,B,C) leading to first, second and third apertures (14A,B,C). Each valve (160A,B,C) includes an aperture (162A,B,C) configured to exhaust gas preferentially before it reaches its respective aperture (14A,B,C) and associated fluid supply (20A,B,C). The preferential release of gas through the apertures (162A,B,C) is encouraged by ensuring each offers less resistance to gas flowing therethrough than gas flowing through its respective outlet aperture (14A,B,C). This may be achieved by making each aperture (162A,B,C) relatively large in comparison to its respective outlet aperture. However, as soon as each aperture (162A,B,C) is blocked, for example by a finger (not shown) or a sealing key (166), gas is forced to flow the length of the respective channel (161A,B,C) and through the respective aperture (14A,B,C).

FIG. 9 shows another alternative fluid supply arrangement (320A,B,C) which may be used in place of previous fluid supply arrangements (20A,B,C) (120A,B,C) (220) and (220′). Again for simplicity, only one fluid supply (320A) of the arrangement is shown, but it will be understood that the other fluid supplies (320B,C) would be configured accordingly. The fluid supply (320A) comprises a member (130′A) which comprises a wick (70) as before. One end (72) of the wick is in contact with the ink in its respective reservoir (22A). The other end (74) of the wick (70) is shrouded with a cover plate (76′) which has an aperture (78′). The cover (76′) is positioned with the aperture (78′) in the path of air flowing (in direction of arrow F) through aperture (14A) of the passageway (14) associated with it. The wick (70) draws ink via capillary action from the reservoir (22A) to the other end (74) of the wick. Attached to the cover plate (76′) is a piezoelectric device (199) which is connected to a controller (210). The controller (210) is, in turn, connected to the regulator (24).

When the piezoelectric device (199) is activated, it applies a force to the cover plate (76′) which causes the end of the wicking material (74) to be squeezed. This squeezing causes fluid to be atomised and expelled from the aperture (78′) and entrained in the gas flow. Repeated activation of the piezoelectric device causes the cover (76′) to vibrate. The rate at which fluid is expelled from the aperture is dependent upon the frequency at which the piezoelectric device is activated. This frequency is determined by the control signal from the controller (210), and the control signal is set by the regulator (24). In this way, the rate at which the fluid is expelled is dependent upon the regulation of the gas flow. The use of piezoelectric devices to squirt atomised fluid into the gas flow allows for the use of very low pressure gas to entrain the fluids.

FIGS. 10A to 10C show various linear valve members (450,450′,450″) which may be used in place of arcuate member (50) as part of a modified regulator (24′) to provide different spray ratio permutations. Thus, the linear valve member 450 includes three channels (451,452 and 453), each of different width or gauge. On the other hand, linear valve member 450′ includes two channels (451′ and 452′) of different gauges. With regard to linear valve member 450″, a simple gearing arrangement (150′) is illustrated schematically in FIG. 10C. By providing the linear valve member 450″ with gear teeth (152′) in meshing engagement with drive cog (154′); the position of the channels (451″, 452″ and 453″) may be accurately controlled.

The invention has now been described in detail for purposes of clarity of understanding. However, it will be appreciated that certain changes and modifications may be practised within the scope of the appended claims.

What is claimed is:

1. Apparatus for spraying a range of mixtures of at least two fluids, comprising:
a body defining a passageway for conveying gas flowing through the body from an inlet to an outlet, the outlet comprising at least two apertures;
at least two fluid supplies, one for each aperture, with each configured to entrain fluid in gas flowing from its respective aperture; and
a regulator for regulating gas flow through each of the apertures, whereby relative quantities of fluid from each fluid supply entrained in gas flowing from the outlet is dependent upon regulation of gas flowing through each aperture.

2. Apparatus according to claim 1, in which the at least two apertures are configured to direct gas flowing therefrom to a common focus.

3. Apparatus according to claim 1, in which at least one fluid supply comprises a member configured to receive fluid from a reservoir through capillarity.

4. Apparatus according to claim 3, in which the member comprises a capillary tube in fluid communication with the reservoir.

5. Apparatus according to claim 4, in which the reservoir comprises a chamber housing absorbent material adjacent one end of the capillary tube.

6. Apparatus according to claim 3, in which the member comprises a wick in fluid communication with the reservoir.

7. Apparatus according to claim 6, in which the wick comprises a wicking material selected from the group consisting of aligned fibres and a sintered material.

8. Apparatus according to claim 6, in which the wick has a peripheral surface facing away from its respective aperture at an acute angle relative to a direction in which gas flows from the outlet.

9. Apparatus according to claim 6, in which the member further comprises an apertured cover plate, shielding the wick from gas flowing from the respective part of the passageway.

10. Apparatus according to claim 9, in which at least one aperture in the cover plate is configured to produce a desired spray profile.

11. Apparatus according to claim 10, in which the at least one aperture has a shape selected from the group consisting of circular, oval, square and rectangular.

12. Apparatus according to claim 10, in which the apertured cover plate configured to produce a first predetermined spray profile is repeatedly interchangeable with another apertured cover plate configured to produce a second predetermined spray profile.

13. Apparatus according to claim 12, in which the wick is configured to be released and interchanged with its respective cover plate.

14. Apparatus according to claim 3, further comprising a plurality of interchangeable supply assemblies, each comprising a plurality of members configured to deliver fluid from their respective reservoir to their respective fluid supplies, each member comprising a wick with a cover plate, with apertures in the cover plates of one supply assembly possibly having a different configuration to those of another supply assembly.

15. Apparatus according to claim 1, in which the regulator comprises at least two valves located in the passageway, each valve configured to regulate gas flowing through a respective outlet aperture.

16. Apparatus according to claim 15, in which at least one valve comprises an open vent configured to exhaust gas before reaching its respective outlet aperture until the vent is sealed.

17. Apparatus according to claim 1, in which the regulator comprises a rotary valve positioned upstream of the outlet aperture.

18. Apparatus according to claim 17, in which the rotary valve comprises an arcuate member with at least one channel therethrough, the at least one channel being registrable with one or other outlet apertures of the passageway by rotation of the arcuate member relative thereto.

19. Apparatus according to claim 18, in which the arcuate member has two channels therethrough, with one channel being wider than the other.

20. Apparatus according to claim 18, in which the rotary valve is repeatedly interchangeable with a further rotary valve, the said rotary valve having a different channel configuration to that of the said further rotary valve.

21. Apparatus according to claim 18, in which rotation of the arcuate member is controlled through a gearing arrangement to provide fine adjustability.

22. Apparatus according to claim 1, further comprising at least two reservoirs, each for supplying fluid to a respective fluid supply.

23. Apparatus according to claim 22, in which the at least two reservoirs are refillable and integrally formed in the body defining the passageway.

24. Apparatus according to claim 22, in which the at least two reservoirs are configured as replaceable cartridges.

25. Apparatus according to claim 22, in which each reservoir includes a wick for delivering stored fluid to its respective fluid supply.

26. Apparatus according to claim 1, in which the passageway outlet comprises a third aperture having a fluid supply configured to entrain fluid in gas flowing from the third aperture, and in which the regulator regulates gas flowing through the third aperture in addition to other outlet apertures.

27. Apparatus according to claim 1, in which the regulator comprises a linear valve positioned upstream of the at least two outlet apertures.

28. Apparatus according to claim 27, in which the linear valve comprises a linear valve member with at least one channel therethrough, the at least one channel being registrable with one or other outlet aperture by displacement of the linear valve member relative thereto.

29. Apparatus according to claim 28, in which the linear valve member has two channels therethrough, with one channel having a different geometrical configuration to the other.

30. Apparatus according to claim 29, in which the linear valve is repeatedly interchangeable with a further linear valve, the said linear valve having a different channel configuration to that of the said further linear valve.

31. Apparatus according to claim 27, in which displacement of the linear valve member is controlled through a gearing arrangement to provide fine adjustability.

32. Apparatus according to claim 1, in which at least one fluid supply comprises a droplet generator configured to generate droplets of fluid for entrainment in the gas flow.

33. Apparatus according to claim 32, in which the droplet generator comprises a piezoelectric element configured to generate fluid droplets when activated.

34. Apparatus according to claim 33, in which the piezoelectric element is coupled to an aperture plate, with the aperture plate being configured to vibrate when excited by the piezoelectric element.

35. A method of spraying a range of mixtures of two or more fluids, comprising:
providing spray apparatus comprising a body defining a passageway with an inlet and an outlet, the passageway comprising at least two apertures;
supplying at least two fluids, each for entrainment in gas flowing from a respective aperture;
regulating gas flow through each aperture to entrain an amount of each fluid in dependence upon gas flow from its respective aperture; and
mixing gas flowing from each aperture to mix entrained fluids.

36. A method according to claim 35, further comprising supplying each of the at least two fluids from a respective reservoir through capillary action.
